(19) United States
(12) Patent Application Publication
(10) Pub. No.: US 2003/0142347 A1
(43) Pub. Date: Jul. 31, 2003

(54) Method and apparatus for embodying documents

(75) Inventors: Athena Christodoulou, Bristol (GB); Richard Taylor, Bristol (GB); Christopher Tofts, Bristol (GB)

Correspondence Address: HEWLETT-PACKARD COMPANY, Intellectual Property Administration, P.O. Box 272400, Fort Collins, CO, 80527-2400, US

(73) Assignee: HEWLETT-PACKARD COMPANY

(21) Appl. No.: 10/303,122

(22) Filed: Nov. 21, 2002

(30) Foreign Application Priority Data
Jan. 31, 2002 (GB) 0202343.0

(51) Int. Cl. G06F 15/00; B41J 1/00

(52) U.S. Cl. 358/1.15

(57) ABSTRACT

An information technology network includes a plurality of printers, at least two of which run a distributed print management programme. The programme operates to monitor all network traffic by snooping, and on the basis of monitored network traffic maintains a log of network printers, their capabilities and status. In addition the programme repeatedly checks for print job notices placed on a spooler, determines on the basis of the updated log which printer under its management is most appropriate to perform the outstanding job, and that printer to retrieve the outstanding job notice and perform the job. Conflicts between different printers retrieving the same job are either resolved by leader election, or preventing conflict by invoking the use within the spooler of a processor instruction known as TEST/SET.

### BACKGROUND TO THE INVENTION

1. Field of the Invention

The present invention relates to the conversion of source data into a document, such as for example, the printing of a document on paper or some other readable medium, from source data such as an electronic data file. A typical example of a source data file representing a document is an electronic data file, created using a word processing program, and which may be embodied by printing onto paper, or display on a computer monitor, for example.

In this specification the term “document” is intended to be interpreted broadly, to encompass within its scope any assimilable manifestation of source data. Thus a “document” may be embodied for visual assimilation (printed on paper, displayed on a monitor), aural (on audio tape) or tactile assimilation (e.g. the printing of Braille), and while printing of a document may indicate one manner in which a document may be embodied (i.e. on tangible “hard” media such as paper), it is not the only way of creating a document from a source data file. The process of converting source data into a document varies widely in dependence upon what is known as the “device implementation” of the source data, that is to say the genus of document to be created (e.g. visual, or tactile), and the specific parameters of the medium on which the document is to be embodied (e.g. in the case of printing, large paper, small paper, etc . . . , or even printing on some other medium such as for example a carpet).

2. Description of Related Art

In the case of printing source data onto paper (or some other printable medium), it is known to connect one or more elements of computing capability (e.g. elements which include both processing and storage capability in any form—e.g. shift registers—being classifiable as either a storage element, or part of a processor) to an electromechanical device adapted to deposit ink onto paper, known in the art as a print engine, in order to produce a printed document. There are a number of different generea of print engine. One genus comprises a print-head supported on a carriage adapted to move laterally relative to an advancing page, so that marks may be deposited on any part of the page by a suitable combination of a lateral motion of the carriage and forward motion of the page. The majority of printers of this type deposit visible indicia on a page, and so are colloquially known as an “inkjet” printer. A further genus, known as a “laserjet” printer has a rotating drum upon which ink (which as indicated above is intended to encompass toner and any other substance which may be used to create indicia, regardless of whether such indicia are visible in certain types of light) is deposited in a predetermined pattern by means of the use of electrostatic charge and a laser; subsequent contact between the surface of the drum and a page deposits the ink from the drum onto the page. In each case operation of the elements of the print engine is controlled by means of the computing elements to which they are connected, with the quality and speed of printing being dependent not only upon the print engine, but also on the operation and capability of the computing elements. Typically the various computing elements which are required in order to: (a) create a source data file; (b) transform the source data file into a set of instructions useable for controlling the print engine; and (c) control the print engine in accordance the aforementioned instructions, are distributed between different physical locations. Some are packaged with the print engine, others with a desktop computer, for example. In commercial vernacular the appliance which includes the print engine is known as a printer, regardless of how much or little computing is performed by any computing elements which may be packaged with the print engine, and operations which are performed in order to produce a printed document from, for example, a document prepared using a word processing package are known as the “print pipeline”.

### SUMMARY OF THE INVENTION

In contemporary information technology, printers and computers are frequently part of a network of, inter alia, one or more other printers and computers, all of which are either interconnectable or interconnected. Thus a user (whether a human user, or computing entity) working at a particular computer will frequently have a choice of a number of printers to use in order to perform a particular print job. The selection the user makes may depend, for example, upon the size of the job, the desired quality of the job and the speed with which the job is required; in addition the user's choice may also be influenced by the availability of a particular printer and its physical proximity.

A first aspect of the present invention relates to the appreciation that an information technology network which includes a plurality of printers has, intrinsically, a potential printing capacity which exceeds the currently achievable actual printing capacity when operated in accordance with existing methods.

According to a first aspect of the present invention, in a network having a plurality of printers, management of printing operations on the network is performed by a distributed print management programme which runs within at least two of the plurality of printers. Where the network includes a mixture of printers running the print management programme and “passive” printers which do not, each passive printer is assigned a management printer as a proxy to manage its printing operations on its behalf.

A first aspect of the present invention thus provides an information technology network including a plurality of printers, at least two of which are adapted to run a distributed print management programme for the network, the programme being adapted to:

monitor traffic within the network to other printers;

establish at a given instant in time, on the basis of the monitored traffic, and data relating to capabilities of other printers in the network, whether a given printer of the plurality is capable of performing a given print job.

In one embodiment each of the printers runs the management programme; alternatively the network comprises a mixture of printers running the programme and printers that don't, with management printers acting as proxies for passive printers. The network may optionally also include a number of printers which are entirely passive, i.e. are neither management printers nor managed by management printers

Typically upon generation of a print job, the job, together with a job notice will be placed on a spooler, or some other shared file storage for the network, and each management printer will poll the shared file storage for pending jobs, and retrieve the source data from the shared file storage upon a determination that it, or a passive printer for which it is the principal is to undertake the job.

Preferably the management programme is adapted to enable management printers to engage in negotiation to resolve any conflicts which may arise from the network model in which jobs are allocated on the basis of retrieval from shared file storage.

A further aspect of the present invention provides a method of operating an information technology network having a plurality of printers comprising the steps of:

using at least two of the plurality of printers to monitor traffic on the networks;

operating processors of each of the aforesaid at least two printers to establish at a given instant in time, on the basis of the monitored traffic and data relating to capabilities of printers within the network, whether a given printer is capable of performing a given print job.

### BRIEF DESCRIPTION OF DRAWINGS

Embodiments of the present invention will now be described, by way of example, and with reference to the accompanying drawings, in which:

FIGS. 1A-E are schematic representations of operations forming part of the print pipeline;

FIGS. 2A and B are schematic representations of an information technology network including a plurality of printers;

FIG. 3 is a schematic illustration of the operation of an embodiment of print management programme according to the present invention; and

FIGS. 4A and 4B are flow-charts illustrating in more detail the operation of part of the programme of FIG. 3

### DESCRIPTION OF PREFERRED EMBODIMENTS

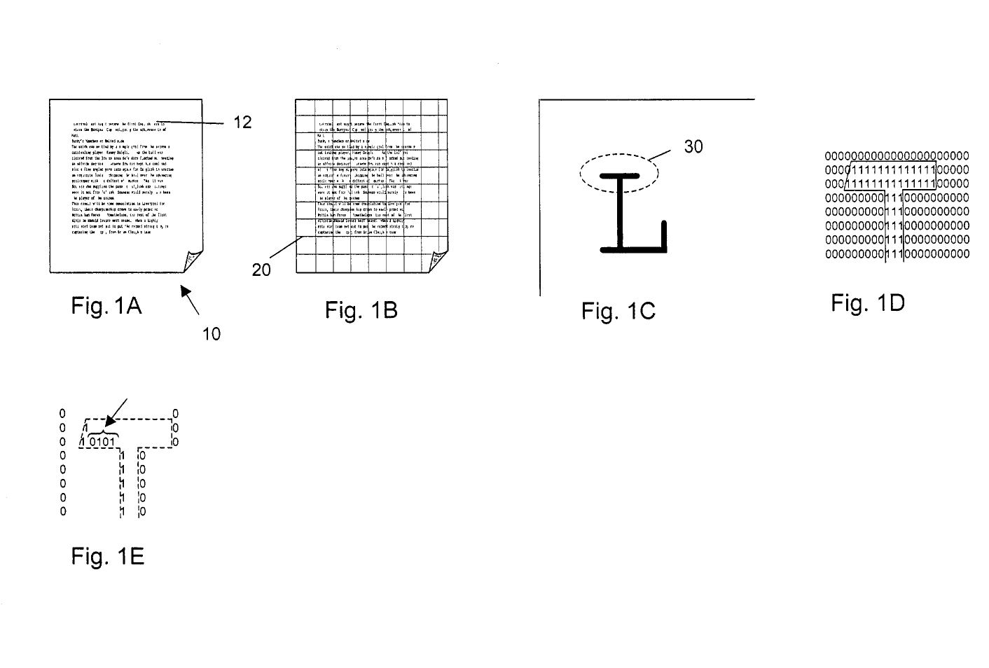

Referring now to FIGS. 1A-E, a document 10 contains lines of text 12 , and both the text and its format on a page are stored within a source data file. The source data file of the document will typically be created by reference to the document itself, the creator of the source file using the document which is created in real time on a computer screen from the source file as visual feedback for the creation of the source file. Typically, for source files created using word processing programs, the form of the source file will be particular to the word processing program that is being used to create it, although as is well known in the art there are features which are common to virtually all such programs. For example, in accordance with an ASCII standard, each letter of the alphabet is represented by a number (e.g. the letter “a” is represented by the number 56); however particular characters used to represent different formats for such letters differ from program to program.

The creation of a printed document from a source data file involves a number of operations which collectively are known as a “print pipeline”. The first operation within the print pipeline is to define a visual image of the document in a computer language called page control language (PCL for short). Referring now to FIG. 1B, this involves defining a page in accordance with a predetermined size (typically determined by the creator of the source file), and dividing the page into a grid of boxes 20, each of which contains a relatively small amount of text. The provision of a representation of the document in PCL may be described in simple terms as breaking the page down into manageable chunks, themselves defined by the boxes 20 of the grid.

Referring now to FIGS. 1C and D, each of the individual grid boxes 20 is then subject to a process known in the art as ripping. Ripping is effectively a raster scan of a grid box 20, the result of which is that the text in the box is represented as an electronic digital array of a series of “1”s and “0”s. Thus the seriph of the capital “L” highlighted within the dashed ellipse 30 in FIG. 1C is seen represented by an array of “1”s against a background of “0”s as illustrated in FIG. 1D (an outline being shown for emphasis only). The resultant digital array (or “bitmap”) of numbers is then used directly to instruct the print engine where to deposit ink on a page, i.e. in the representation of FIG. 1D it is intended that ink is to be deposited by the print engine wherever there are “1”s, with the spacing between adjacent bits typically being equal to the smallest indexing movement of the print engine which is repeatably achievable. An intrinsic characteristic of the ripping process is that because of the volume of processing operations required it is not possible to determine in advance the amount of time required to rip a given PCL file. Following ripping, the ripped data is stored, typically on one or more of the storage elements of the printer which is performing the printing. The ripped data is typically stored because, given the relatively large processing time, it is desirable to perform ripping of a document only once, and it frequently occurs that the print engine is not able to act upon the ripped data in real time, e.g. because it is busy, or simply because it is not able to operate sufficiently fast to keep up with the ripping process. However storage of ripped data creates a further problem, because of the relatively large volume of data produced by the ripping process; the better the ripping process in respect of a given document the larger quantity of data that is produced, and as with the time required to complete a ripping operation, it is not possible to determine in advance the amount of data which will be produced by ripping process (there usually being an ephemeral requirement during the course of the ripping process for more storage—e.g. disk—space than simply the amount of storage space used to store the end result of the ripping process). It is thus necessary to compress the ripped data prior to storage, and an example of compressed ripped data is illustrated in FIG. 1E. The compression routine defines, for each row, the first bit of a section of the row where all subsequent bits are of the same type, and adjacent to that first bit, a binary number equal to the number of identical bits that follow in that row. Thus for example, the first bit of an exemplified part of a row in FIG. 1E is a “1”, and is followed by the number “0101” (the number “10” in binary), indicating that 10 further bits of value “1” follow, thus constituting a saving of 6 bits stored (the ten bits that would have been stored in the absence of compression, less the four that are required in order to indicate the presence of these ten in uncompressed data).

In connection with the print pipeline described above, it should be noted that the form of source data is to an extent dependent upon perspective. Thus for example, from the perspective of preparing the PCL file, the source data will be the file created by the word processing program used to create the source data. However, from the perspective of the ripping operation, the source data may be regarded as the PCL file.

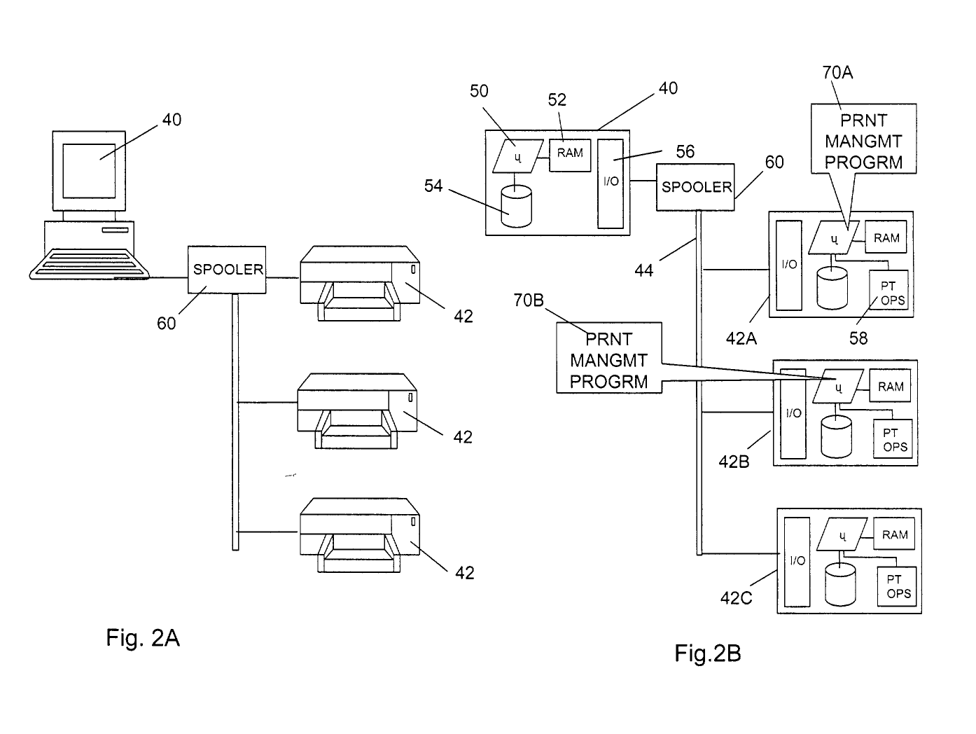

Referring now to FIGS. 2A and B, the network of hardware elements for performing the operations thus far described includes a standard desktop PC 40, and a plurality of printers 42, all of which are interconnected via network links 44. The computer 40 and printers 42 include similar computing hardware elements, including in each case a processor 50, RAM 52, hard disc storage 54 and an input/output function (including LAN card, etc., as appropriate) 56, which will typically include an USB. In addition, each of the printers 42 have the mechanical elements necessary for performing printing operations, i.e. a print engine, together with feed and finishing elements, all of which are represented schematically by the designation “Pt Ops”, and having the reference numeral 58. A network element known as a spooler 60, which has the function of acting as a shared file storage between the computer and the printers is also provided, and comprises a storage disk and processor (not shown). Spoolers and their function are known per se and shall not be discussed further.

While existing printers have hardware which is similar from a functional point of view to that of computers, typically the hardware is configured, whether by application or system software, such that its capabilities are somewhat different to those of a computer. For example each of the printers will be equipped with what is, from a functional perspective, relatively standard application software, whose purpose is the performance of ripping, compression, and storage operations. In addition, each printer will also be provided with system software, typically stored on the hard disc storage 54, to enable the printers to receive and process relatively large volumes of data (e.g. documents to be printed), and to send status information regarding the progress of a particular print job (or, in the case of an “error” message, the lack of such progress). A typical print operation involving the elements of the network described above operating in their usual (i.e. prior art) manner involves the dispatch to a particular printer of a source data file, which the printer in question then processes in the manner described in relation to FIGS. 1A-E above. During the course of this procedure, the printer is adapted to send back status information to the controlling computing entity regarding the number of pages processed and printed, or, in the event of a problem with the printing operation, an error message.

In accordance with this embodiment of the present invention, when a user at computer 40 requests printing of a job, they will do so via a user interface on which they are able to specify various options, such as the preferred physical location at which they require the print job to be completed. These options, once specified, are used to create ajob notice detailing the nature of the job and the options selected by the user. The job notice may possibly include the job itself, or alternatively may have a pointer to the location at which the job is stored, is then posted on the shared network file storage, provided in this instance by the spooler 60.

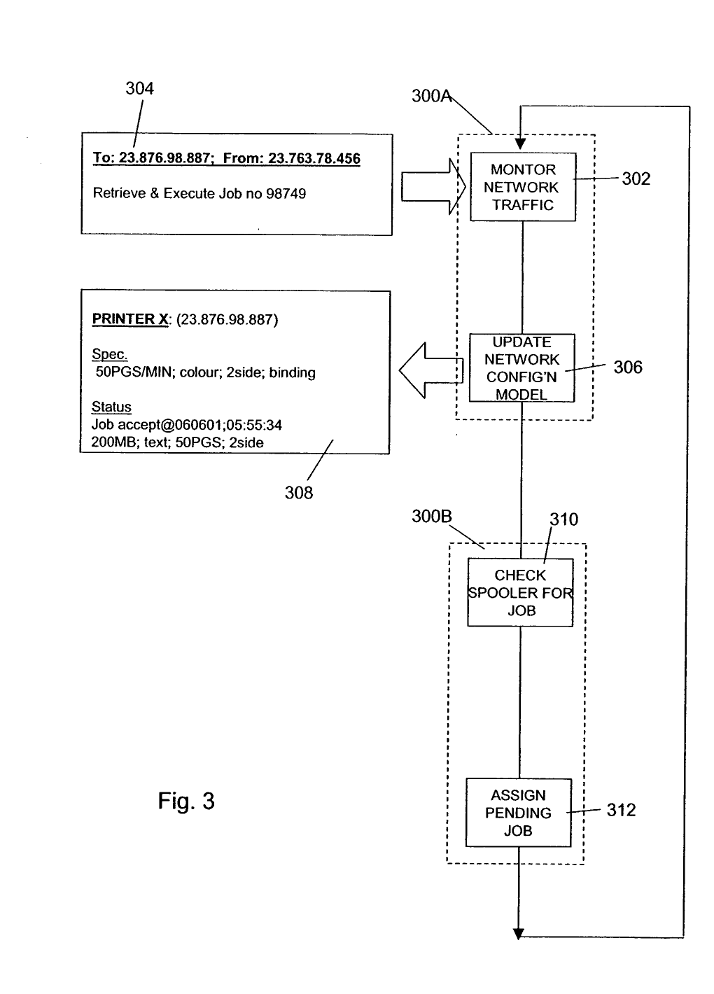

Two of the three network printers, 42A and 42B are additionally each provided with a distributed print management programme, schematically denoted 70A and 70B respectively in FIG. 2B. The printer 42C does not run such a programme, and so is referred to as being a passive printer, as opposed to a managing printer, and has been assigned printer 42A as a managing proxy printer, which will therefore perform all print management tasks on behalf of the passive printer 42C. Each of the print management programmes runs a continuous loop of procedures, known in the art as a daemon, and this is illustrated schematically in FIG. 3. Referring now to FIG. 3 the daemon essentially performs two tasks: network monitoring to obtain information globally referenced as 300A, and using the information obtained from global step 300A, assigning and managing execution of print job, globally referenced in FIG. 3 as 300B. Each of these generally denoted steps 300A,B may essentially be thought of as comprising two elements. Thus, one of the procedures which a print management programme performs is, as denoted by step 302, the monitoring of network traffic, known in the art as “snooping”. Simply put, this simply involves recording and processing packets of data sent along the network, whether they are intended explicitly for the network address hosting the print management programme performing the snooping operation or not. Thus for example in FIG. 3, a typical snooping operation by the management programme running on printer 42B will intercept a packet 304 which is a message to the passive printer 42C from is proxy printer 42A. This message includes the network addresses of the sending and receiving printers (typically denoted by a string of numbers), together with an instruction, in this case to printer 42C to retrieve and execute job No. 98749 from the shared file storage provided in this instance by the spooler 60. Other messages that are typically intercepted by a print management programme while snooping include, for example instances when a new printer is connected to the network, and broadcasts to all other entities on the network one or more message packets specifying its capabilities, or error messages from a printer for example. The print management programme maintains a log of each printer on the network (whether a management printer or a passive printer, and whether it is acting as a proxy for a given passive printer or not), and upon receiving a message such as the message 304, the management programme updates the log. Thus, at step 306, the print management programme updates the log 308 for printer X to reflect that printer X (also defined by the network address specified in the message 304) accepted ajob at 05:55 am (and 34 sees.) on Jun. 6, 2001, and the nature of the job accepted (i.e. size of the source data file, nature of the job—here text—, the number of pages, and finishing information—here 2 sided). The management programme is once again able to obtain this data by snooping when the printer 42C retrieves the job, since details of the job will be contained within the message packet used to retrieve the job from the spooler (alternatively details of the job could be obtained directly from the spooler using the job notice ID in the original message). Thus using such intercepted messages, the print management programme is then able to maintain up-to-date (as defined in the context of the frequency of message interceptions) data on the status of each printer in the network. In addition it can be seen from the log 308, that details of the intrinsic capabilities of each printer are likewise maintained within the log 308 for a given printer. At step 310 the print management programme checks the spooler to determine whether there are any job notices to be executed, and, if there are, then at step 312 the programme assigns an outstanding job either to itself, or to one of the printers for whom it is acting as a proxy.

In a modification, network traffic may be monitored by a process known as “broadcast”, as opposed to the use of snooping. In broadcast mode, each entity within the network transmits every message to every other entity within the network in addition to its intended recipient or recipients. That is to say that the message header includes as destinations for the message all entities in the network. In practice this is similar to snooping, one of the principal differences being that unlike with snooping, a management printer which wishes to monitor network traffic does not need to be configured to intercept messages who's header does not specify them, which it would not otherwise do.

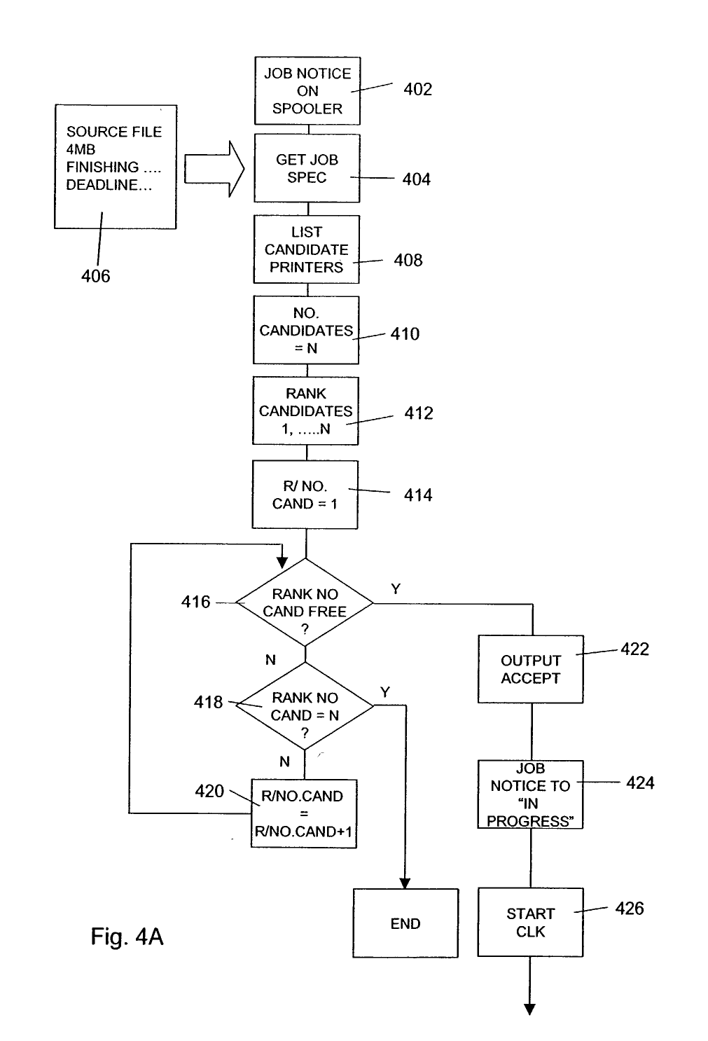

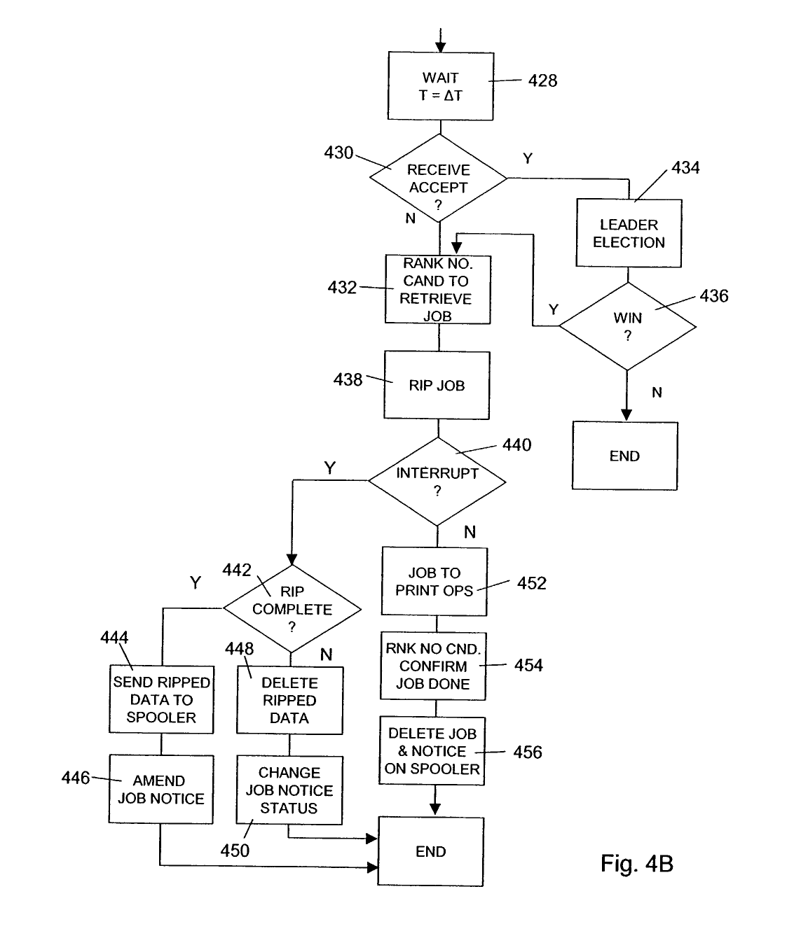

Referring now to FIGS. 4A and B, the operation of the part 300B of the daemon of FIG. 3 will now be described in more detail. The process starts at step 402, with the print management programme checking the spooler 60 for unallocated job notices, and in the event that an unallocated job is present on the spooler 60, at step 404 the programme retrieves the specification 406 of the job. At step 408 the programme matches the retrieved job specification against the log of printer capabilities which it maintains to generate a list of candidate printers. The candidate list will take into account initially intrinsic printer capabilities, and then the most up-to-date information maintained in the log with regard to the extent to which each of the printers is already committed to performing print jobs, and may therefore not be available to perform the job notice under consideration within the time specified within it. Having generated a list of candidates, the programme initialises a variable N, equal to the number of candidates, at step 410, and then ranks the candidates in order of preference for suitability to perform the job at step 412. At step 414 a variable R./No CAND is initialised at a value of 1, this variable effectively being a counter for which numbered candidate in the ranked list of candidates is currently under consideration by the programme, and then a decision step 416 determines whether the ranked numbered candidate under consideration is in fact available by interrogating the candidate printer directly. If it is not, for example because it has in the meantime run out of print media, or has developed a fault, then at step 418 the programme determines whether the variable R/No CAND has attained the value N, in which case all of the candidates would have been unavailable for one reason or another, and so there would be no printers under the management of this programme available to perform the job and the programme ends. If however the variable R/No. CAND has not attained a value N, then at step 420 its value is augmented by 1 and the programme returns to decision step 416. When, following decision step 416 it is established that a given candidate printer is available to do the job, the management programme sends an ACCEPT signal identifying the job notice throughout the network at step 422, the purpose of which will become clear later, and then at step 424 alters the status of the job notice to “IN PROGRESS” the effect of which is that no other printer will attempt to perform the job once such a notice is in place. However, alteration of the job notice status to “IN PROGRESS” though relatively fast, nonetheless takes a finite amount of time. It is therefore possible that another printer may retrieve and perform the job while the status is being changed. In this situation, to prevent both such printers operating on the job notice, a clock is started at step 426, and the programme's operation suspended for a time period AT, the time required for an ACCEPT signal output from another printer which had retrieved the job in the time window referred to above to reach the programme. Thus, if by expiry of the time ΔT no ACCEPT signal has been received, then it follows that the present print management programme is the only printer in possession of the print job (the “IN PROGRESS” status of the job on the spooler now preventing retrieval of the job), and at step 432 the programme instructs the ranked number printer which was provisionally allocated the job to retrieve the job and print it. If however another ACCEPT signal is received, then there is a conflict between the two printers which emitted this signal. This conflict is resolved at step 434 using a technique called leader election. In one example of Leader Election each of the printers which has both output and received an ACCEPT signal generates a random number, and the printer with the lowest number is the one that proceeds with the print job. At step 436 the programme determines whether it has won the leader election process, whereupon if it has then the programme proceeds to step 432 discussed above.

In a modification, instead of performing the leader election process, the use of an instruction within the processor of the spooler known as TEST/SET may be invoked. This provides mutual exclusion during critical decision-making procedures, ensuring that, in this situation only one printing entity is able to retrieve the job notice.

At step 438 the job is ripped, and at step 452 the ripped data is sent to the print ops of the printer in question. A diagnostic step 440 checks whether this process has been completed without interruption (further diagnostic steps may be added at various other points in the procedure if desired). If subsequent to an interruption it is established that the ripping has been completed, then at step 444 the ripped data is sent to the spooler (rather than waste the processing time required to rip the source data), and the job notice amended accordingly at step 446 to reflect that the job now simply involves processing the ripped data by print ops. If however the ripping is incomplete, then the data thus far acquired is deleted at step 448, and the job notice status is changed from IN PROGRESS at step 450, to a status indicating that the entire job is outstanding. In the absence of an interruption, at step 454 the printer selected by the management printer (which may be itself) for performing the job confirms that the job has been completed, whereupon the job notice is deleted from the spooler 60 and the programme ends.

It should be noted that where the programme of the present invention provides of aborting of print jobs previously undertaken, the cyclic nature of the daemon illustrated in FIG. 3 means that the aborted job will once again automatically fail to be considered by the distributed print management programme until sufficient resources are available to perform the job.

As mentioned previously, printers include a relatively large amount of processing and storage capability which might more ordinarily be associated with computers, and in contemporary commercial terms the distinction between printer and computer turns primarily upon which of the two includes the print operations functionality. It may be the case that a printer in a network possesses storage and processing capability which is remotely located in geographical (both in the IT network and the more ordinary sense) terms, but which is specifically allocated to that printer (which does not exclude co-allocation to another printer) for the purpose of ripping, compressing and storing data. Indeed it is sometimes the case that the ripping for a particular printer takes place inside the computer which is being used to dispatch source data to the printer in question for printing. It is thus on occasions difficult to establish whether a particular block of computing functionality is, in functional terms, part of a particular printer. One relatively straightforward (though not exhaustive) test is to view the issue from the perspective of the print manager which is controlling the network printing operation. Thus, for example, if a particular element or elements of computing capability appear to the print manager to be operating on behalf of the print operations function of a particular printer, then they should be considered for the purposes of the present invention to comprise part of that printer, even though, for example, they may well be physically located in the same computer which is operating the print manager.

Reference has been made, in order to exemplify the methods and apparatus' of the present invention to the creation of source data files using word processing programs. It is to be emphasised that source data files for printing may come from many sources and have many forms, including without limitation, automatic utility bill generating software, for example, to provide many different types of “document”.

1. An information technology network including a plurality of printers, at least two of which are adapted to run a distributed print management programme for the network, the programme being adapted to:
monitor traffic within the network to other printers;
establish at a given instant in time, on the basis of the monitored traffic, and data relating to capabilities of other printers in the network, whether a given printer of the plurality is capable of performing a given print job.

2. An information technology network according to claim 1 including at least one printer on which the distributed print management programme is not running, and whose print functions are managed by the print management programme of a pre-designated printer equipped with such a programme.

3. An information technology network according to claim 1 wherein the distributed print management programme is additionally adapted to instruct the given printer to perform the given print job.

4. An information technology network according to claim 1 wherein the distributed print management programme is additionally adapted to instruct a printer on behalf of whom it is operating to retrieve a print job available from a spooler, and to perform the print job.

5. An information technology network according to claim 4 wherein each of the distributed print management programme is adapted, in the event that two or more printers retrieve the job from the spooler, to perform leader election to determine which of the printers that retrieved the job from the spooler shall perform the job.

6. An information technology network according to claim 1 wherein the print management programme monitors network traffic by snooping.

7. An information technology network according to claim 1 wherein network traffic is broadcast to all entities within the network to enable monitoring of the traffic by the distributed print management programme operating on the at least two printers.

8. A method of operating an information technology network having a plurality of printers comprising the steps of:
using at least two of the plurality of printers to monitor traffic on the network;
operating processors of each of the aforesaid at least two printers to establish at a given instant in time, on the basis of the monitored traffic and data relating to capabilities of printers within the network, whether a given printer is capable of performing a given print job.

9. A method according to claim 8 wherein the processors of the at least two printers additionally operate to instruct a given printer to perform a print job.

10. A method according to claim 9 wherein the processors of the at least two printers additionally operate to instruct a given printer to retrieve the given print job from network shared file storage.

11. A method according to claim 8 wherein the step of monitoring traffic on the networks includes the step of snooping on network traffic.

12. A method according to claim 8 further comprising the step of updating a log of network printer capabilities and status on the basis of monitored network traffic.

13. A method according to claim 12 wherein the step of establishing whether a given printer is capable of performing a given print job is performed on the basis of data within the log.

14. A printer for use in an information technology network, the printer having a programme adapted to:
monitor network traffic to other network printers; and
establish, on the basis of the traffic to the other network printers, and data relating to capabilities of the other network printers, whether, at a particular instant in time, a specified one of the other network printers is capable of performing a specified print job.

15. A printer according to claim 14, wherein the programme is adapted to perform leader election with a similar programme operating on a computing entity other than the printer.
